(19) United States
(12) Patent Application Publication
(10) Pub. No.: US 2006/0272468 A1
(43) Pub. Date: Dec. 7, 2006

(54) DUAL CUT SURGICAL SAW BLADE

(75) Inventors: Parag Gupta, Portage, MI (US); Mag O'Keeffe, Cork (IE)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: STRYKER INSTRUMENTS, Kalamazoo, MI (US)

(21) Appl. No.: 11/465,052

(22) Filed: Aug. 16, 2006

Related U.S. Application Data
(63) Continuation of application No. 10/856,597, filed on May 28, 2004, now abandoned.
(60) Provisional application No. 60/474,591, filed on May 30, 2003.

(51) Int. Cl. B23D 57/00

(52) U.S. Cl. 83/835

(57) ABSTRACT

A surgical saw blade operatively couples to an oscillatory power tool for oscillation about an oscillation axis (OA). The saw blade includes a plurality of cutting teeth separated from one another by a clean out opening along a distal end. The clean out opening comprises an arcuate closed end and straight side walls extending from the closed end. Each tooth comprises first and second rake surfaces and first and second relief surfaces intersecting to define first and second cutting edges, respectively. The first and second cutting edges are oppositely disposed from one another. One cutting tooth protrudes a distance (de) from one side face of the blade and the next adjacent cutting tooth protrudes the same distance (de) from the other side face of the blade to cut a groove having a width (dg) wider than the thickness (t) of the blade.

### CROSS-REFERENCES TO RELATED APPLICATIONS

This application is a continuation of U.S. patent application Ser. No. 10/856,597, filed May 28, 2004, which claims the priority and benefits of U.S. Provisional Application Ser. No. 60/474,591 filed May 30, 2003.

### BACKGROUND OF THE INVENTION

1. Field of the Invention

The subject invention relates to micro saw blades, and more particularly to a dual-cut micro saw surgical blade used in surgical operations for removing tissue, cartilage, and bone.

2. Background of the Related Art

Typically, surgical saw blades of different designs are used in small bone surgeries and osteotomies such as foot, oral, maxillofacial and mandibular surgery and are known in the prior art. The surgical saw blades are typically mounted on a drive unit by which they can be induced to perform an oscillating reciprocating movement to carry out, for instance, precise bone or tissue cuts. When using such surgical saw blades, it is important that the cuts are carried out precisely at the correct position and that the surrounding bone is not damaged more than necessary.

A typical prior art surgical saw blade includes a tooth pattern that typically incorporates a space between adjacent teeth, which is further defined by surfaces which lie in planes generally perpendicular to the flat surfaces of the surgical saw blade. This pattern is satisfactory in various applications wherein the teeth of the surgical saw blade exit the cut and deposit cuttings, stored in the space, outside the cut. In this mode of the surgical saw blade operation, the teeth typically do not leave the cut, whereby cuttings tend to build up in the space between the teeth thereby reducing the efficiency and speed of the surgical saw blade.

In addition, the state of the art discloses many other designs of surgical saw blades, which include crossed teeth engagement. However, such crossed surgical saw blades are not sufficiently precise and have the disadvantage, wherein the surgical saw blade becomes untrue during cutting operations, thereby providing unprecise non-perfect cut of the bone or the tissue and reducing a precise and smooth cut of wedge, thereby limiting good cut efficiency.

On some of the current micro blades on the market, the kerf has the same contour as the blade cut edge; this causes “kicking” to occur. This is caused by the cutting edge lying on the same radius as the radius of the tool rotation. All teeth engage at the same time, hence causing the blade to grab sending a force back through the hand piece to the surgeon. This sudden unpredictable movement causes inaccuracy in the cut, and requires greater control and focus from the surgeon in anticipation of the “kick.”

Another disadvantage noted in existing micro blades is the tendency of the blade to initially wander to the side rather than form a kerf. Most of the current micro blades have teeth that are oriented in an arc of constant radius, with the nature of small bone surgery where the bone is quite round having a small radius of curvature, we tend to get the a situation where, the curved blade meets the curved bone hence giving a point of contact which is extremely small leading to a tendency of the blade to wander before grabbing the bone.

In cutting, the rake angle that the cutting edge makes with the material being cut is very critical. If the angle is an acute angle, it is called a negative rake and if it is an obtuse angle, it is called a positive rake. The negative rake angle tooth is stronger but requires more cutting force. Tooth profile with positive rake angle is not as structurally strong but require less cutting force resulting in better cutting performance. A negative rake angle is disclosed in U.S. Pat. No. 3,905,374 to Winter and a positive rake angle is disclosed in later U.S. Pat. No. 5,122,142 to Pascaloff. In Pascaloff's design, the positive rake was introduced, however, half the teeth pointed in one direction whereas the other half pointed in another direction. The cutting performance improved because of positive rake but the blade did not have good control because only half of the edge on one side was engaged.

Various surgical saw blade patterns are shown in U.S. Pat. No. 5,306,285 to Miller et al; U.S. Pat. No. 5,423,845 to McDaniel; and PCT Publication No. WO 93/01751 to Kay et al.; and U.S. Pat. Nos. 6,022,353 and 6,503,253 to Fletcher et al. The U.S. Pat. No. 5,448,833 to Coon discloses a tooth pattern in a hand saw for cutting sheet rock or gypsum, but the teeth are all within the side planes of the side faces of the blade.

During the last thirty years, there has not been much progress in the micro blades. Most micro blades today still have the negative rake. The main reason for this is that positive rake reduces tooth strength and micro blades are one third or one-fourth the thickness of heavy-duty blade. So the challenge in the micro world was how to design a micro blade with a positive rake tooth, preferably with the dual cut and ensure that the tooth does not shear off while cutting.

### BRIEF SUMMARY OF THE INVENTION AND ADVANTAGES

The present invention provides a specific tooth design in a surgical saw blade for penetrating bone by being operatively coupled to an oscillatory power tool. The surgical saw blade comprises a shank having opposite side faces defining a uniform thickness with side edges and extending between a proximal end and a distal end. The proximal end has a hub defining an oscillation axis (OA) for attachment to an oscillatory power tool for driving engagement thereby. A plurality of cutting teeth along the distal end of the blade are separated from one another by a clean out opening. The clean out opening comprises an arcuate closed end and straight side walls extending from the closed end. Each of the cutting teeth comprises a first rake surface and a first relief surface intersecting to define a first cutting edge and a second rake surface and a second relief surface intersecting to define a second cutting edge. The first and second cutting edges are oppositely disposed from one another. The adjacent cutting teeth are offset in opposite directions from each other so that one cutting tooth protrudes from one side of the blade and the next adjacent cutting tooth protrudes from the other side of the blade for cutting a groove wider than the thickness of the blade.

This novel combination in tooth design for a surgical blade provides uniform cutting and ensures that each tooth is subjected to the same chip load. So compared to the present dual cut design in a heavy-duty blade, the root of the tooth on the side of the blade in this new design will be under less stress. Not all of the teeth might be completely engaged at any one time but the maximum engagement happens close to a longitudinal axis resulting in better control and less vibration of the blade. In addition, the micro dual cut has one generous radius between teeth to reduce the stress concentration due to bending of the tooth during cutting and to channel away debris, and the like. The stress concentration is not an issue in a heavy-duty blade but it becomes an issue in a micro blade because of reduced thickness of the blade. As a result of implementing the dual cut tooth profile and ensuring equal chip load on the micro dual saw blade, the subject invention outperforms other relate art micro saw blades.

### BRIEF DESCRIPTION OF THE SEVERAL VIEWS OF THE DRAWINGS

Other advantages of the present invention will be readily appreciated as the same becomes better understood by reference to the following detailed description when considered in connection with the accompanying drawings wherein:

FIG. 1 is a perspective view showing the surgical saw blade operatively coupled to an oscillatory power tool shown in phantom;

FIG. 2 is a plan view of the surgical saw blade showing on side face;

FIG. 3 is a side view taken along line 3-3 of FIG. 2 and showing one side edge of the blade;

FIG. 4 is an enlarged fragmentary view of the teeth in the circle 4 of FIG. 2;

FIG. 5 is yet a further enlarged fragmentary view of two of the teeth shown in the circle 5 of FIG. 4;

FIG. 6 is an enlarged fragmentary side view of the teeth in the circle 6 of FIG. 3; and

FIG. 7 is a plan view similar to FIG. 2 but showing the line of teeth on an arc struck about the oscillation axis.

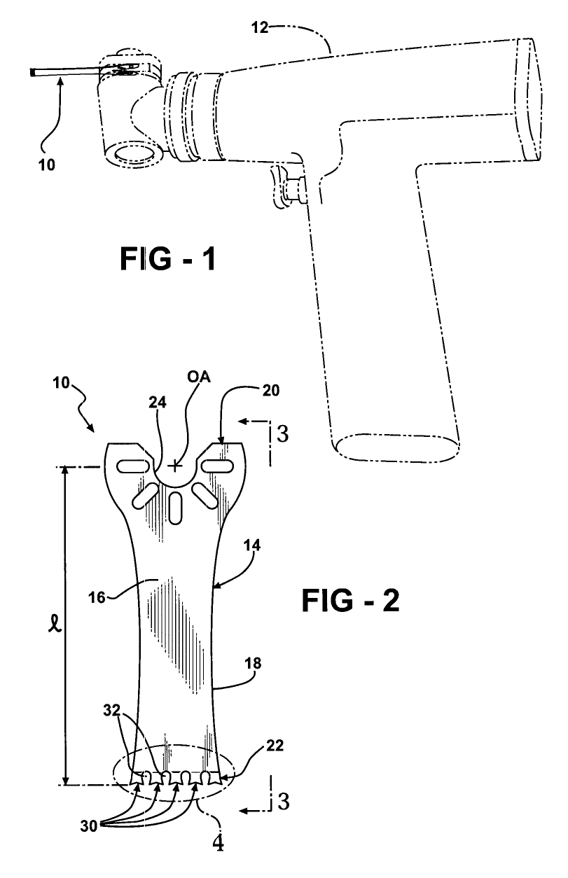

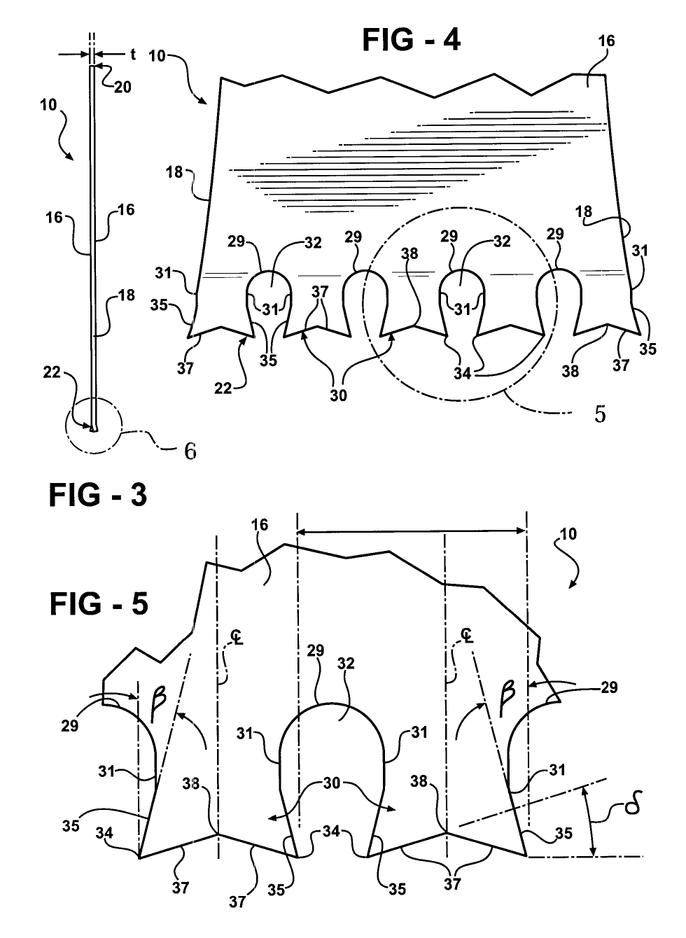

### DETAILED DESCRIPTION OF THE INVENTION

Referring to the Figures, wherein like numerals indicate like parts throughout the several views, a surgical saw blade 10 for penetrating bone is generally shown at 10. The surgical saw blade 10 is operatively coupled to an oscillatory power tool 12 for oscillation about an oscillation axis OA.

The surgical saw blade 10 comprises a shank, generally indicated at 14, having a uniform thickness (t) defining opposite side faces 16 extending between a proximal end, generally indicated at 20, and a distal end, generally indicated at 22. The surgical saw blade 10 has side edges 18 that also extend between the proximal end 20 and the distal end 22. The blade 10 is formed from flat stock with the shank 14 being waisted between the ends 20, 22 by inwardly bowed side edges 18 thereby being narrower between the ends thereof.

The proximal end 20 is bulbous and includes a semi-circular slot 24 centered on the oscillation axis (OA) and symmetrical with the longitudinal axis of the blade 10 and a plurality of holes 26 to facilitate connection to a oscillatory power tool for driving engagement thereby.

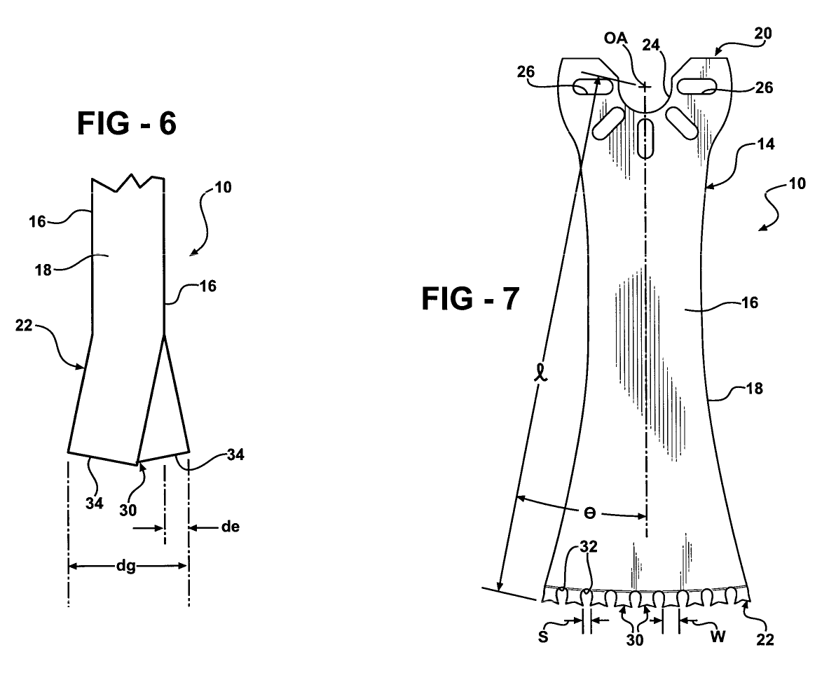

A plurality of cutting teeth, each generally indicated at 30, are separated from one another by a clean out opening 32 along the distal end 22. The distal end 22 is illustrated as being straight in FIG. 2 and is illustrated as being arcuate or curved in FIG. 7. Each cutting tooth 30 is alternately offset from one another in opposite directions for cutting a groove wider (dg) than the thickness (t) of the shank. In other words, one cutting tooth may extend from the cutting surface to one direction and another tooth extends to another direction. For example, referring to FIG. 6, one cutting tooth 30 protrudes a distance (de) from one side face 16 of the blade 10 and the next adjacent cutting tooth 30 protrudes the same distance (de) from the other side face 16 of the blade 10. The offset provides for cutting a groove having a width (dg) wider than the thickness (t) of the blade 10.

The clean out opening 32 is disposed between adjacent cutting teeth 30 and each clean out opening 32 has a maximum width greater than the distance between the cutting edges 34 of adjacent cutting teeth 30. With reference to FIGS. 2 and 4, the clean out opening 32 comprises an arcuate closed end 29 and straight side walls 31 extending from the closed end 29. Between the straight side walls 31, a substantially consistent width is provided for each of the cutting teeth 30 which is believed to reduce the stress concentration due to bending of the tooth 30 during cutting. In other words, the cutting tooth 30 has a root portion disposed back of the cutting edge 34 and the root portion has the substantially consistent width to reduce the stress while cutting. The clean out opening 32 also assists to channel away debris.

Referring to FIG. 6, each of the teeth 30 comprises first and second rake surfaces 35 and first and second relief surfaces 37. The first rake surface 35 and the first relief surface 37 intersect to define a first cutting edge 34. The second rake surface 35 and the second relief surface 37 intersecting to define a second cutting edge 34. The cutting edges 34 are oppositely disposed from one another. Each cutting edge 34 has a length equal to the thickness (t) of the blade 10. The rake surfaces 35 and the relief surfaces 37 are best illustrated in FIG. 5. The rake surface 35 extends transversely to the straight side walls of the clean out opening 32. It is to be appreciated by one of ordinary skill in the art of surgical saw blades that a rake angle is defined as the angle between the leading edge of a cutting tool and a perpendicular to the surface being cut. A positive rake angle is defined when the rake surface is behind the perpendicular relative to the direction of movement. The angle of the rake surface 35 is generally indicated at β and the angle of the relief surface 37 is indicated at δ. Surgical saw blades formed according to the subject invention provide the first cutting edge 34 that presents a positive rake when the saw blade moves in one direction and the second cutting edge 34 that present a positive rake when the saw blade moves in an opposite direction. The subject invention presenting the two positive rake angles results in better control and less vibration and reduces the stress concentration due to bending of the tooth 30 during cutting. The angle of the relief surface 37 is defined relative to the generally horizontal cutting surface. The angle of the relief surface 37 is important to prevent the non-cutting edge from rubbing on the cutting surface. If the non-cutting edge rubs, the saw blade will overheat and cause early dulling. Therefore, a proper relief angle reduces friction and minimizes heat generation while in operation. It is well known that if excessive temperature occurs during cutting, thermal necrosis, or death of cells due to heat, is likely to occur and additional repair will be required after surgery.

In further definition of the design of each tooth 30, as best shown in FIG. 5, each tooth 30 includes a V-shaped valley between the cutting edges 34, formed by the intersection of the relief surfaces 37. Each V-shaped valley has an apex 38 disposed on the centerline (c/l) of the tooth 30.

Referring to FIG. 7, the distance along the distal end 22 between the cutting edges 34 of each tooth 30 defines the tooth width (w) and the distance between the cutting edges 34 of adjacent teeth 30 across the clean out opening 32 defines tooth space (s) whereby the tooth width (w) plus the tooth space (s) equals the tooth pitch (p). The arc of excursion is defined by the angle (θ).

The tooth width (w) plus two times the tooth spacing (s) equals or is greater than the angle of excursion (θ) expressed in degrees divided by three hundred and sixty degrees times two pie (π) times the radius (1) of the arc of the distal end 22. This is:
w+2s=or>21πθ/360

It has been discovered preferable for the ratio of tooth width (w) divided by tooth spacing (s) to be between zero (0) and three (3). By equation substitution, it is preferable that the tooth pitch (w+s) divided by the tooth width (w) be between one (1) and four (4).

Obviously, many modifications and variations of the present invention are possible in light of the above teachings. The invention may be practiced otherwise than as specifically described within the scope of the appended claims. In addition, the reference numerals in the claims are merely for convenience and are not to be read in any way as limiting.

What is claimed is:

1. A surgical saw blade for penetrating bone by being operatively coupled to an oscillatory power tool, the surgical saw blade comprising:
a shank having a thickness (t) defining opposite side faces extending between a proximal end and a distal end, said shank having side edges;
said proximal end having a hub for attachment to an oscillatory power tool for driving engagement thereby, said hub defining an oscillation axis (OA);
a plurality of cutting teeth spaced from one another and extending from said distal end of said shank and alternately offset from one another in opposite directions for cutting a groove wider (dg) than said thickness (t) of said shank;
a clean out opening disposed between adjacent teeth, said clean out opening comprising an arcuate closed end and straight side walls extending from said closed end;
each of said cutting teeth comprising a first rake surface and a first relief surface intersecting to define a first cutting edge and comprising a second rake surface and a second relief surface intersecting to define a second cutting edge, wherein said first and second cutting edges are oppositely disposed from one another;
wherein said first rake surface presents a positive rake angle when said saw blade moves in one direction and said second rake surface presents a positive rake angle when said saw blade moves in an opposite direction; and
said rake surfaces extending transversely to said straight side walls.

2. A surgical saw blade as set forth in claim 1 wherein each tooth includes a valley between said cutting edges thereof.

3. A surgical saw blade as set forth in claim 2 wherein said valley is V-shaped with the apex of the valley disposed on the centerline of said tooth.

4. A surgical saw blade as set forth in claim 1 wherein each cutting edge has a length equal to said thickness (t) of said blade.

5. A surgical saw blade as set forth in claim 1 wherein said clean out opening has a maximum width greater than the distance between the cutting edges of adjacent teeth for providing a relief behind each cutting edge.

6. A surgical saw blade as set forth in claim 1 wherein the distance between said cutting edges of each tooth defines the tooth width (w) and the distance between the cutting edges of adjacent teeth across said clean out opening defines tooth space (s) whereby the tooth width (w) plus the tooth space (s) equals the tooth pitch (p).

7. A surgical saw blade as set forth in claim 6 wherein said tooth pitch (p) divided by the tooth width (w) is between one and four.

8. A surgical saw blade as set forth in claim 1 wherein said shank is waisted between said ends thereby being narrower between said ends hereof.

9. A surgical saw blade as set forth in claim 1 wherein said cutting teeth are offset (de) in opposite directions from each other so that one cutting tooth protrudes (de) from one side face of said blade and the other cutting tooth protrudes (de) from the other side face of said blade for cutting a groove wider (dg) than said thickness (t) of said blade.

10. A surgical saw blade as set forth in claim 1 wherein each of said cutting teeth comprise a root portion disposed back of said cutting edge and said root portion having a substantially consistent width.
